(19) United States
(12) Patent Application Publication
(10) Pub. No.: US 2013/0318314 A1
(43) Pub. Date: Nov. 28, 2013

(54) MANAGING COPIES OF DATA ON MULTIPLE NODES USING A DATA CONTROLLER NODE TO AVOID TRANSACTION DEADLOCK

(71) Applicants: Mircea Markus, London (GB); Manik Surtani, London (GB)

(72) Inventors: Mircea Markus, London (GB); Manik Surtani, London (GB)

(73) Assignee: RED HAT, INC., Raleigh, NC (US)

(21) Appl. No.: 13/481,635

(22) Filed: May 25, 2012

(51) Int. Cl. G06F 12/16

(52) U.S. Cl. 711/162; 711/E12.103

(57) ABSTRACT

A data controller node receives a request to update data stored at the data controller node for a transaction managed by a transaction originator node. The data controller node locks the data at the data controller node and identifies copies of the data residing at other nodes. The data controller node sends a message to the other nodes to update the copy at the other nodes without locking the copy of the data at the other nodes. The data controller node determines whether an acknowledgment is received from each of the other nodes that the copy of the data are updated for the transaction and updates the locked data at the data controller node for the transaction in response to receiving the acknowledgment from each of the other nodes.

### TECHNICAL FIELD

Embodiments of the present invention relate to transaction deadlock, and more particularly, to managing copies of data on multiple nodes using a data controller node to avoid transaction deadlock.

### BACKGROUND

Data storage systems may store redundant copies of data to help prevent data loss. The data may be used by multiple transactions. For example, a first transaction (TX1) may be to deduct money from the balance of a bank account. A separate second transaction (TX2) may be to add money to the balance of the same bank account. Typically, the transactions would update each copy of the bank account data to maintain data consistency between the redundant copies. In traditional data storage systems, data consistency between the redundant copies can be achieved by a data locking mechanism to prevent data from being corrupted or invalidated when multiple transactions try to write to the same data. When a lock of the data is acquired for a transaction, the transaction has access to the locked data until the lock is released. Other transactions may only have read access to the locked data. Thus, each transaction attempts to acquire a lock on each copy of data. If a transaction can obtain a lock on each copy, the transaction will typically update the data. If the transaction cannot obtain a lock on each copy, the transaction will typically not update the data until a lock has been acquired on each copy.

Transaction deadlock may occur when two transactions that write to the same data execute concurrently or execute nearly at the same time. A deadlock is a situation wherein two or more competing actions are each waiting for the other to finish, and thus, neither transaction finishes. For example, there are two copies of the bank account data. The first transaction (TX1) wishes to acquire locks on the first copy and the second copy. A second transaction (TX2) wishes to acquire locks the first copy and the second copy. If the transactions run in parallel, TX1 may obtain a lock on the first copy, and TX2 may obtain a lock on the second copy. TX1 would like to progress and acquire a lock on the second copy, but would not be able to do so since the second copy is already locked by TX2. Similarly, TX2 would try to acquire a lock on the first copy, but would not be able to do so since the first copy is already locked by TX1. Each transaction waits for the other transaction to finish causing a deadlock.

Traditional solutions typically wait for a deadlock to occur and then build a dependency graph describing the dependencies between the deadlocked transactions. Generally, conventional solutions terminate one of the two deadlocked transactions. Such traditional solutions may be quite costly because they involve a large amount of CPU and network usage, which is not ideal. Such solutions are generally also not fast enough in terminating a deadlocked transaction.

### BRIEF DESCRIPTION OF THE DRAWINGS

Various embodiments of the present invention will be understood more fully from the detailed description given below and from the accompanying drawings of various embodiments of the invention.

FIG. 1 illustrates exemplary network architecture, in accordance with various embodiments of the present invention.

FIG. 2 is a block diagram of an embodiment of an update request module in a transaction originator node.

FIG. 3 is a block diagram of one embodiment of using a data controller node to update multiple copies of transaction data to avoid transaction deadlock.

FIG. 4 is a block diagram of an embodiment of a data controller module in an enlisted node.

FIG. 5 is a flow diagram illustrating an embodiment for a method of managing updates to copies of data to avoid transaction deadlock.

FIG. 6 is a block diagram of an exemplary computer system that may perform one or more of the operations described herein.

### DETAILED DESCRIPTION

Described herein are a method and apparatus for managing copies of data on multiple nodes using a data controller node to avoid transaction deadlock. A data grid has multiple operating system processes. A process can run a data grid node, which is an instance of a data grid application. A process “owning” transaction data has a capability to perform operations, such as acquiring data locks, updating values, etc. for the transaction. A process that owns transaction data for a transaction is hereinafter referred to as an “enlisted process.” A node running in an enlisted process is hereinafter referred to as an “enlisted node.” Redundant copies of transaction data may reside on multiple enlisted nodes to prevent data loss.

A process that initiates and manages a transaction is hereinafter referred to as a “transaction originator process.” A node running in a transaction originator process is hereinafter referred to as a “transaction originator node.” Transaction data for the transaction may not be owned by the transaction originator node and the transaction originator node can communicate with the one or more enlisted nodes which own the transaction data for a transaction.

The data that is owned by the enlisted nodes can be used by multiple transactions. For example, a first transaction, which is managed by a first transaction originator node, N1, may be to deduct money from the balance for a bank account. A separate second transaction, which is managed by a second transaction originator node, N2, may be to add money to the balance of the same bank account. Three enlisted nodes, N3, N4, and N5, may own a copy of the data for the bank account.

To avoid transaction deadlock, in one embodiment, when either of the transaction originator nodes, N1 and/or N2, is ready to make changes to the copies of the transaction data (e.g., bank account data) at the enlisted nodes (e.g., N3, N4, N5), the transaction originator node(s) can identify the data to lock for the transaction, determine which of the enlisted nodes is the data controller node for the data, and send an update request to the data controller node to update the copy of the data at the data controller node and the other enlisted nodes which have a copy of the data. The data controller node can receive the update request, lock its local copy of the data, and send a message to the other enlisted nodes that store a copy of the data to update a value in the copy of the data at the corresponding enlisted node without locking the copy of the data at the corresponding enlisted node. When the data controller node receives multiple update requests to update the same data, the data controller node can queue the requests.

Embodiments avoid deadlocks by ensuring that transactions attempting to update the same data use the same data controller node to manage the updates. Embodiments reduce processing time by not having to acquire locks on the redundant copies of the data at multiple nodes to update the data.

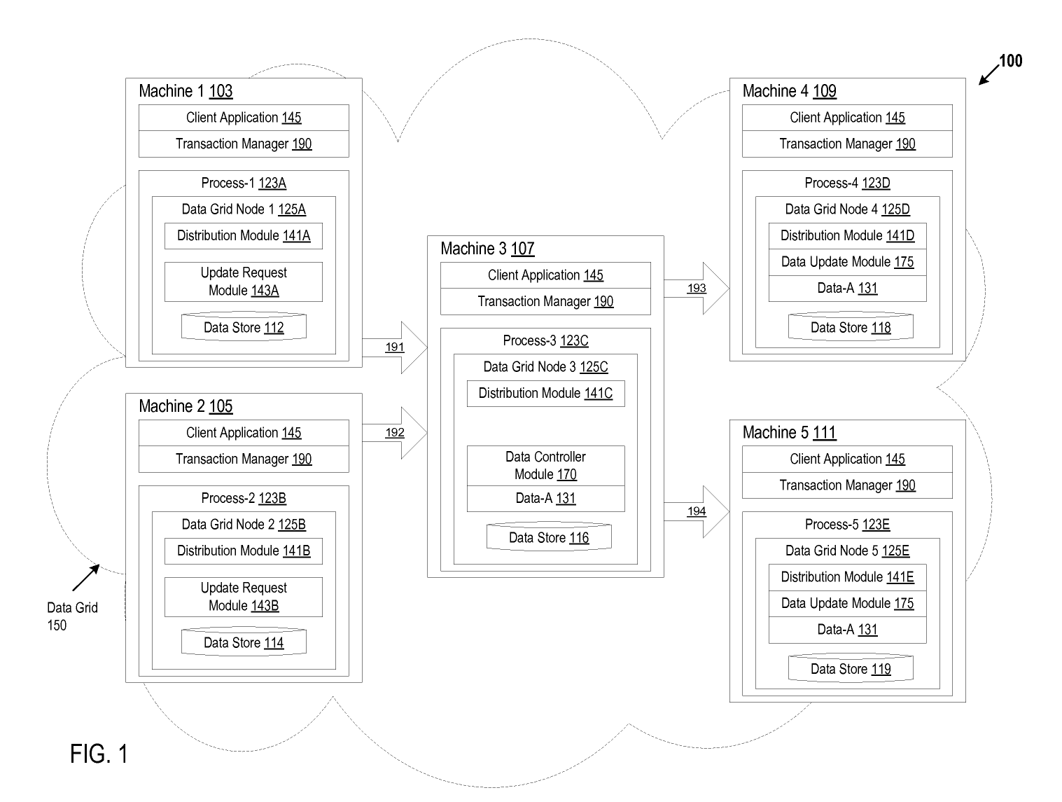

FIG. 1 is an exemplary network architecture 100 in which embodiments of the present invention can be implemented. The network architecture 100 can include multiple machines 103,105, 107,109,111 connected via a network (not shown). The network may be a public network (e.g., Internet), a private network (e.g., a local area network (LAN)), or a combination thereof.

The machines 103,105,107,109,111 may be configured to form a data grid 150. Data grids are an alternative to databases. A data grid 150 distributes data across multiple operating system processes. The operating system processes can run an instance of a data grid application and can use a distribution algorithm to determine which processes in the data grid 150 are enlisted nodes that have the data for a transaction. Each process can own data and allow other processes access to the data. Unlike a database, the distributed data of a data grid 150 removes single points of failure by storing redundant copies of data on multiple enlisted nodes.

Machines 103,105,107,109,111 may be hardware machines such as desktop computers, laptop computers, servers, or other computing devices. Each of the machines 103,105,107,109,111 may include an operating system that manages an allocation of resources of the computing device. In one embodiment, one or more of the machines 103,105,107,109,111 is a virtual machine. For example, one or more of the machines may be a virtual machine provided by a cloud provider. In some instances, some machines may be virtual machines running on the same computing device (e.g., sharing the same underlying hardware resources). In one embodiment, one or more of the machines 103,105,107,109,111 is a Java Virtual Machine (JVM), which may run on a hardware machine or on another virtual machine.

Machines 103,105,107,109,111 each include one or more processes 123A-E. A process 123A-E is an operating system process (e.g., a Java Virtual Machine instance). A process 123A-E can run a data grid node (also hereinafter referred to a “node”) 125A-E, which is an instance of a data grid application. A process 123A-E runs one data grid node 125A-E. For example, Process-1 123A runs data grid node 125A. A machine 103,105,107,109,111 can run more than one process 123A-E and a corresponding data grid node 125A-E.

Each data grid node 125A-E may act as a server to clients and as a peer to other data grid nodes 125A-E. An in-memory data grid 150 may rely on main memory for data storage. In-memory data grids 150 are faster than disk-optimized data grids since disk interactions are generally much slower than in-memory interactions. For brevity and simplicity, an in-memory data grid 150 is used as an example of a data grid throughout this document.

In one embodiment, the in-memory data grid 150 operates in a client-server mode, in which the in-memory data grid 150 serves resources (e.g., a stateful data store 112,114,116,118,119 such as a cache) to client applications 145. In one embodiment, a machine 103,105,107,109,111 is a client machine hosting one or more applications 145. An application 145 can be any type of application including, for example, a web application, a desktop application, a browser application, etc. An application 145 can be hosted by one or more machines 103,105,107,109,111. In one embodiment, the in-memory data grid 150 acts as a shared storage tier for client applications 145. A separate memory space may be generated for each client application 145. In one embodiment, a client application 145 runs outside of the virtual machines (e.g., machines 103,105,107,109,111) of the data grid nodes 125A-E. In another embodiment, a client application 145 runs in the same virtual machine as a data grid node 125A-E. In another embodiment, a client application 145 may not be a Java-based application and may not be executed by a Java Virtual Machine.

A process 123A-E in the data grid 150 may execute data operations, such as to store objects, to retrieve objects, to perform searches on objects, etc. Unlike a database, the in-memory data grid 150 distributes stored data across data stores 112,114,116,118,119 (e.g., cache-nodes, grid-nodes) in the multiple processes 123A-E. The in-memory data grid 150 can include a volatile in-memory data structure such as a distributed cache. Each process 123A-E can maintain a data store 112,114,116,118,119 (e.g., cache-node, grid-node). In one embodiment, the data grid 150 is a key-value based storage system to host the data for the in-memory data grid 150 in the data stores 112,114,116,118,119.

The key-value based storage system (e.g., data grid 150) can hold and distribute data objects based on a distribution algorithm (e.g., a consistent hash function). For example, the data grid 150 may store bank account objects with a key-value model of (accountNumber, accountObject). The data grid 150 can store a particular key-value pair by using a distribution algorithm to determine which of the processes 123A-E stores the particular value for the key-value pair and then place the particular value within that process. Each process 123A-E of the data grid 150 can use the distribution algorithm to allow key look up.

A client application 145 can initiate a transaction by communicating a start of a transaction to a transaction manager 190. A transaction manager 190 communicates with a client application 145 and with the various processes 123A-E in the data grid 150 to manage the transaction. In one embodiment, each of the processes 123A-E includes a transaction manager 190 to allow a client application 145 to initiate a transaction with any process 123A-E in the data grid 150.

When a client application 145 is writing data to the data grid 150, the client application 145 can connect to a transaction manager 190 of the transaction originator node it is working with in the data grid 150 and provide the key-value pair (e.g., accountNumber, BankAccount instance) to the transaction manager 190. For example, a client application 145 may connect to transaction originator node, Node 1 (125A), which is managing a first transaction TX1 to deduct money from a bank account (e.g., Data-A 131), and passes a key-value pair for Data-A (131) to the transaction originator Node 1 (125A) to change the data in the data grid 150.

The data in the enlisted nodes (e.g., Node 3 125C, Node 4, 125D, Node 5 125E) can be used by multiple transactions. For example, a client application 145 may connect to another transaction originator node, Node 2 (125C), which is managing a second transaction TX2 to add money to the same bank account which is used by TX1, and passes a key-value pair for Data-A (131) to the transaction originator node Node 2 (125B) to change the data in the data grid 150.

Data consistency in the data grid 150 can be achieved by a data locking mechanism to prevent data from being corrupted or invalidated when multiple transactions try to write to the same data. When a lock of the data is acquired for a transaction, the transaction has access to the locked data until the lock is released. Other transactions may not have write access to the locked data.

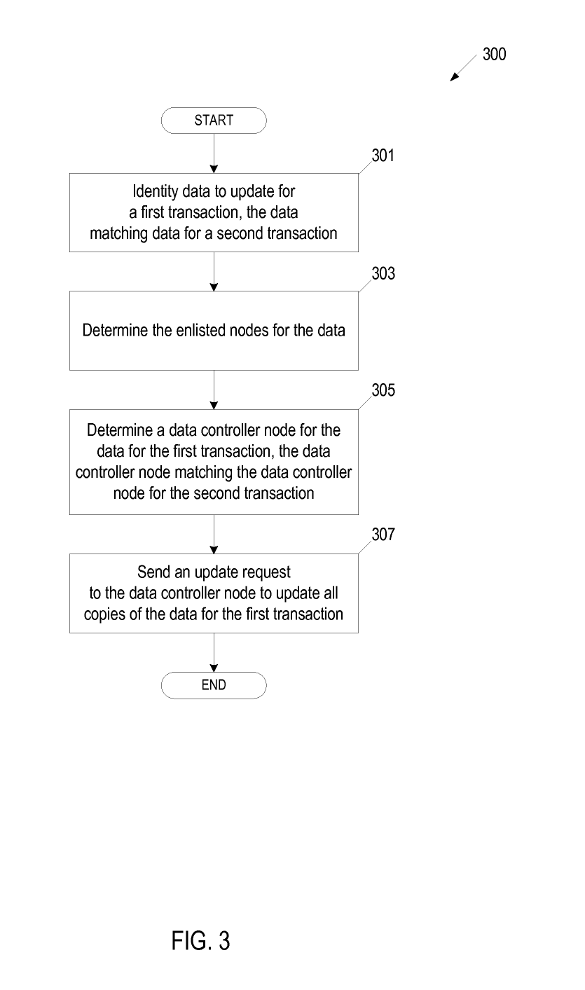

A deadlock may occur when two transactions (e.g., TX1, TX2) that write to the same data (e.g., Data-A 131) execute concurrently or nearly at the same time. To avoid deadlock, the transaction originator nodes (e.g., Node 1 125A, Node 2 125B) can include an update request module 143A,B to determine which of the enlisted nodes (e.g., Node 3 125C, Node 4 125D, Node 5 125E) is the data controller node for the data (e.g., Data-A 131). For example, the update request modules 143A,B in the transaction originator nodes (e.g., Node 1 125A, Node 2 125B) determine that Node 3 (125C) is the data controller node for Data-A 131. One embodiment of the update request module 143A,B determining which enlisted node is the data controller node is described in greater detail below in conjunction with FIG. 3. The update request modules 143A,B can send 191,192 an update request for their corresponding transactions (e.g., TX1, TX2) to the data controller node (e.g., Node 3 125C) to update the data (e.g., Data-A 131) at the data controller node and the data (e.g., Data-A 131) at the other enlisted nodes (e.g., Node 4 125D, Node 5 125E).

The data controller node (e.g., Node 3 125C) can include a data controller module 170 to receive 193,194 the update requests from transaction originator nodes (e.g., Node 1 125A, Node 2 125B) and manage the requests to avoid a deadlock between the multiple transactions. For example, the data controller module 170 can receive 191 an update request for TX1 from Node 1 125A to update Data-A 131. The data controller module 170 may receive 192 an update request for TX2 from Node 2 125B to update the same Data-A 131 and may place the second update request in a queue. For the update request from Node 1 125A, the data controller module 170 can lock its local copy of Data-A 131 and send 193,194 a message to the other enlisted nodes, Node 4 125D and Node 5 125E, to update a value in their corresponding copy of the Data-A 131 without locking their corresponding copy of Data-A 131. A process 123A-E can include a distribution module 141A-E to determine, based on the key (i.e., accountNumber) and a distribution algorithm, which node(s) in the data grid 150 are the enlisted nodes where the data is stored.

The enlisted nodes (e.g., Node 4 125D, Node 5 125E) can include a data update module 175 to receive the message from the data controller module 170 to update the copy of the data (e.g., Data-A 131) at the corresponding enlisted node. The data update module 175 can use the key-pair in the message to update the data without obtaining a lock on the data. The data update module 175 can send a message to the data controller module 170 indicating whether the data at the corresponding enlisted node has been successfully updated. The data update module 175 may receive a message from the data controller module 170 to rollback the value of the data (e.g., Data-A 131) to a previous state, for example, if not all of the enlisted nodes (e.g., Node 4 125D, Node 5 125E) were able to successfully update the data. The data update module 175 can rollback the value of the data to a previous state.

When Node 4 125D and Node 5 125E have successfully updated their corresponding copy of Data-A 131, the data controller module 170 can update its local copy of Data-A 131 and release the lock on the local copy. If the data controller module 170 has a request in its queue (e.g., request received 192 from Node 2 125B), the data controller module 170 can process the request since the lock on the data has been released.

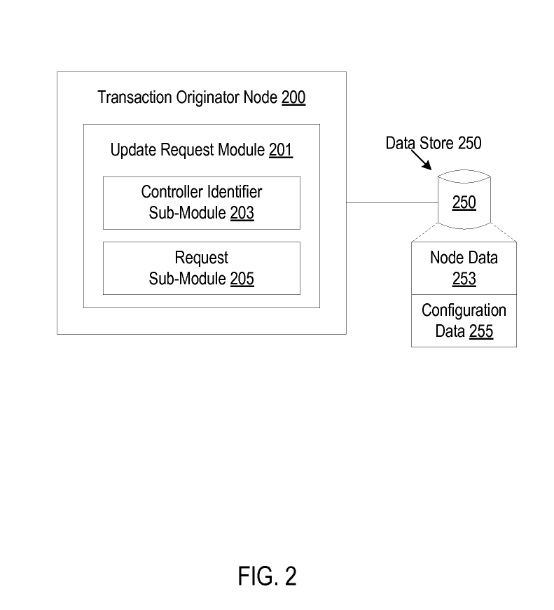

FIG. 2 illustrates a block diagram of one embodiment of an update request module 201 in a transaction originator node 200. The transaction originator node 200 may correspond to process 123A and data grid node 125A running in machine 103 of FIG. 1 and to process 123B and data grid node 125B running in machine 105 of FIG. 1. The transaction originator node 200 includes an update request module 201. The update request module 201 can include a controller identifier sub-module 203 and a request sub-module 205.

The controller identifier sub-module 203 can receive a request to update data in the data grid for a transaction. The request can be received from a client application (e.g., client application 145 in FIG. 1). The controller identifier sub-module 203 can use a data identifier (e.g., key) in the request and a distribution algorithm in the request to identify which nodes in the data grid are the enlisted nodes that own the data. One embodiment of determining which nodes are the enlisted nodes for the data is described in greater detail below in conjunction with FIG. 3. The controller identifier sub-module 203 can determine which of the enlisted nodes is the data controller node for the data. In one embodiment, the controller identifier sub-module 203 accesses node data 253 in a data store 250 that is coupled to the controller identifier sub-module 203 to identify the data controller node for the data. The node data 253 can be a list of the nodes in the data grid. The controller identifier sub-module 203 can identify the data controller node based on the positions in the list of the corresponding enlisted nodes. In another embodiment, the controller identifier sub-module 203 determines a hash value for each of the enlisted nodes using a node identifier corresponding to each of the enlisted nodes and ranks the enlisted nodes based on the hash values. The controller identifier sub-module 203 can select the data controller node based on configuration data 255 that is stored in the data store 250. Embodiments of determining which of the enlisted nodes is the data controller node is described in greater detail below in conjunction with FIG. 3.

The request sub-module 205 can send an update request to the data controller node. The request can include a key-value pair identifying the data to be updated and the value to use to update the data. The request can include a transaction identifier.

A data store 250 can be a persistent storage unit. A persistent storage unit can be a local storage unit or a remote storage unit. Persistent storage units can be a magnetic storage unit, optical storage unit, solid state storage unit, electronic storage units (main memory), or similar storage unit. Persistent storage units can be a monolithic device or a distributed set of devices. A ‘set’, as used herein, refers to any positive whole number of items.

FIG. 3 is a flow diagram of an embodiment of a method 300 of using a data controller node to update multiple copies of transaction data to avoid transaction deadlock. Method 300 can be performed by processing logic that can comprise hardware (e.g., circuitry, dedicated logic, programmable logic, microcode, etc.), software (e.g., instructions run on a processing device), or a combination thereof. In one embodiment, method 300 is performed by an update request module 143A in a transaction originator node 125A executing in a machine 103 of FIG. 1 or by an update request module 143B in a transaction originator node 125B executing in a machine 105 of FIG. 1.

At block 301, processing logic identifies data to update for a first transaction. Processing logic can receive a request, for example, from a client application, that identifies the data to be updated for the first transaction. The data matches data for a second transaction managed by another transaction originator node. The data resides remotely at more than one enlisted node, which may be different from the transaction originator nodes.

At block 303, processing logic determines the enlisted nodes for the data. The request from the client application can include a key-value pair that identifies the data that is to be updated. Processing logic can use the key in the received key-value pair and an algorithm to identify which nodes in the data grid are the enlisted nodes that own the data for the key. For example, processing logic may determine that Node 3, Node 4, and Node 5 each have a copy of Data-A which is to be updated. In one embodiment, the algorithm is a non-cryptographic hash function. In one embodiment, the algorithm is a consistent hash algorithm. In one embodiment, the algorithm is a Murmur Hash function.

At block 305, processing logic determines which of the enlisted nodes (e.g., Node 3, Node 4, and Node 5) that store the data is the data controller node for the data for the first transaction. The data controller node for the first transaction matches a data controller node for the second transaction. In one embodiment, the processing logic identifies the data controller node based on the positions in a list of the nodes in the data grid. In one embodiment, processing logic searches for the enlisted nodes in the list and selects the enlisted node having a position closest to the top of the list as the data controller node. In another embodiment, processing logic searches for the enlisted nodes in the list and selects the enlisted node having a position closest to the bottom of the list as the data controller node. Processing logic can select the data controller node based on configuration data that is stored in a data store that is coupled to the update request module.

In another embodiment, processing logic determines a hash value for each of the enlisted nodes (e.g., Node 3, Node 4, and Node 5) using a node identifier corresponding to each of the enlisted nodes and ranks the enlisted nodes based on the hash values. In one embodiment, the algorithm is a non-cryptographic hash function. In one embodiment, the algorithm is a consistent hash algorithm. In one embodiment, the algorithm is a Murmur Hash function. In one embodiment, processing logic orders the hash values from a least hash value to a greatest hash value. In another embodiment, processing logic orders the hash values from a greatest hash value to a least hash value. In one embodiment, processing logic selects the enlisted node having the greatest hash value as the data controller node. In one embodiment, processing logic selects the enlisted node having the smallest hash value as the data controller node. Processing logic can select the data controller node based on configuration data that is stored in a data store that is coupled to the update request module.

At block 307, processing logic sends an update request to the data controller node for the first transaction. The request can include a key-value pair identifying the data to be updated and the value to use to update the data. The request can include a transaction identifier. Method 300 can be an iterative method. The number of iterations can be based on the number of the update requests received from clients applications.

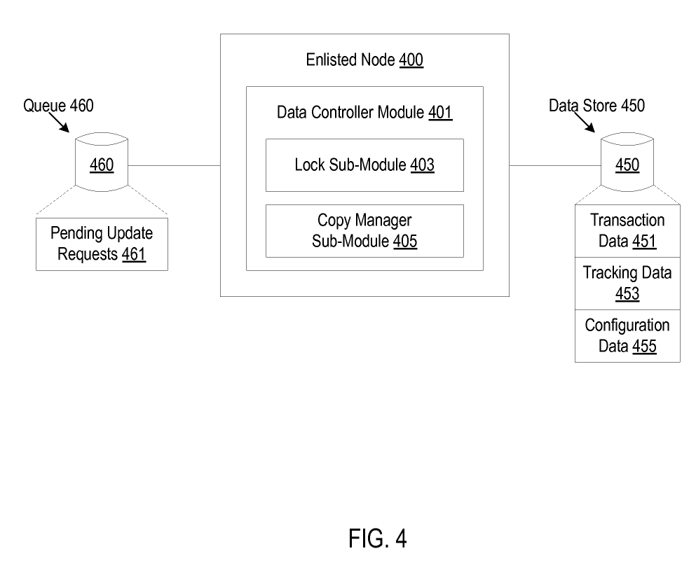

FIG. 4 illustrates a block diagram of one embodiment of a data controller module 401 in an enlisted node 400 that is identified to be a data controller node. The enlisted node 400 may correspond to enlisted process 123C and data grid node 125C running in machine 107 of FIG. 1. The enlisted node 400 includes a data controller module 401. The data controller module 401 can include a lock sub-module 403 and a copy manager sub-module 405.

The data store 450 is coupled to the enlisted node 400 and can store transaction data 451 that can be used by multiple transactions. The transaction data 451 is data that is owned and maintained by the enlisted node 400. The data store 450 can be a cache. The data store 450 can be a persistent storage unit. A persistent storage unit can be a local storage unit or a remote storage unit. Persistent storage units can be a magnetic storage unit, optical storage unit, solid state storage unit, electronic storage units (main memory), or similar storage unit. Persistent storage units can be a monolithic device or a distributed set of devices. A ‘set’, as used herein, refers to any positive whole number of items.

The transaction data 451 can include key-value pairs. The transaction data 451 can be used by multiple transactions concurrently or nearly at the same time. For example, the transaction data 451 includes Data-A. Data-A may be a balance for Bank-Account-A. Data-A may be used by two transactions TX1 and TX2. TX1 may involve deducting money from Data-A. Nearly the same time TX1 is executing, TX2 may involve adding money to Data-A.

The lock sub-module 403 can receive update requests from any number of transaction originator nodes to update multiple copies of data for a transaction. The lock sub-module 403 can add pending update requests 461 to a queue 460 that is coupled to the lock sub-module 403. For example, the lock sub-module 403 may receive an update request from a first transaction originator node for TX1 and may concurrently or nearly at the same time receive an update request from a second transaction originator node for TX2. The lock sub-module 403 can process the request for TX1 and add the request for TX2 to the queue 461, or vice-verse.

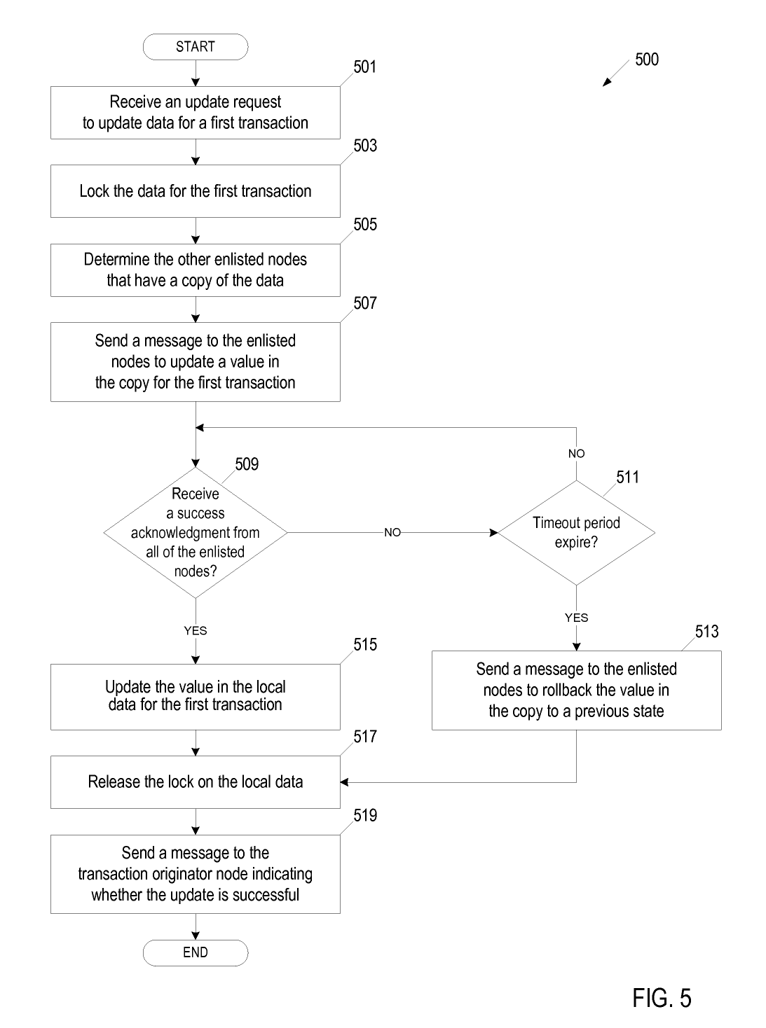

The update request can be a network call (e.g., remote procedure call (RPC)). The update request can include one or more keys identifying the transaction data 451 to be updated and a new value for each key. The update request can include a request to acquire a lock on the transaction data 451 for the requested keys and to update the values associated with the keys using the new values in the update request. The lock sub-module 403 can acquire a lock on the transaction data 451 and can update the current value for a key in the transaction data 451 based on the new value received in the update request. In one embodiment, the lock sub-module 403 updates the transaction data 451 after receiving acknowledgment that the other copies of the transaction data at the other enlisted nodes have been updated. The lock sub-module 403 can store tracking data 453 to monitor whether an acknowledgment is received from the other enlisted nodes. One embodiment of updating the transaction data is described in greater detail below in conjunction with FIG. 5. The lock sub-module 205 can send a message to the transaction originator node indicating whether the copy of the transaction data 451 at the data controller node and the other copies of the transaction data at the other enlisted nodes were successfully updated or not. In one embodiment, the lock sub-module 403 uses a timeout period to determine whether to update the transaction data 451 or not. The timeout period can be stored in configuration data 455 in the data store 450.

The lock sub-module 403 can release the lock on the locked transaction data 451 to allow other transactions access to the updates made to the transaction data 451. When the lock sub-module 403 releases the lock on the transaction data 451, the lock sub-module 403 can check the queue 460 to determine whether there is a pending update request 261 to be processed and process the pending requests 261.

The copy manager sub-module 405 can use a data identifier (e.g., key) from the update request and a distribution algorithm to identify which nodes in the data grid are the enlisted nodes that own a copy of the transaction data 451. The copy manager sub-module 405 can send a message to the other enlisted nodes storing a copy of the transaction data 451 to update a value in the copy of the data at the corresponding enlisted node without locking the copy of the data at the corresponding enlisted node. The message can be a network call (e.g., remote procedure call (RPC)). The message can include one or more keys identifying the transaction data 451 to be updated and a new value for each key.

FIG. 5 is a flow diagram of an embodiment of a method 500 of a data controller node managing updates to copies of data to avoid transaction deadlock. Method 500 can be performed by processing logic that can comprise hardware (e.g., circuitry, dedicated logic, programmable logic, microcode, etc.), software (e.g., instructions run on a processing device), or a combination thereof. In one embodiment, method 500 is performed by a data controller module 170 in a data controller node 125C executing in a machine 107 of FIG. 1.

At block 501, processing logic receives an update request to update data for a first transaction. Copies of the data reside at the data controller node and at least one other enlisted node in the data grid. The request can be received from a transaction originator node. Processing logic can receive the update request via a network call over the network. Processing logic may receive another update request from a different transaction originator node for a different transaction that uses the same data during the execution of method 500 and may add the request to a queue.

At block 503, processing logic locks the data for the first transaction. The request can include the key that corresponds to the data that should be locked and the corresponding new value for the key. The key that should be locked corresponds to a key related to a write operation. At block 505, processing logic determines which nodes in the data grid are the enlisted nodes that own a copy of the transaction data. Processing logic can use a data identifier (e.g., key) from the update request and a distribution algorithm to identify which nodes in the data grid are the enlisted nodes that own a copy of the transaction data. At block 507, processing logic sends a message to the enlisted nodes to update a value for the first transaction in the copy of the transaction data without locking the copy of the transaction data at the enlisted nodes. Processing logic can send a message that includes the key and the new value for the key. The message can be a network call (e.g., remote procedure call (RPC)).

At block 509, processing logic determines whether there is an acknowledgment received from all of the enlisted nodes indicating that the update was made successfully. Processing logic can store tracking data in a data store that is coupled to the data controller module to determine whether a successful acknowledgment is received from all of the nodes. If processing logic does not receive a successful acknowledgment from all of the enlisted nodes (block 509), processing logic determines whether a timeout period has expired at block 511. Processing logic can use a timeout period from configuration data that is stored in the data store. The timeout period can be user-defined. If a timeout period has not expired (block 511), processing logic returns to block 509, to determine whether a successful acknowledgment is received from all of the enlisted nodes. If a timeout period has expired (block 509), processing logic sends a message to the enlisted nodes to rollback the value to a previous state at block 513. For example, one of the enlisted nodes may experience a system failure and may not have successfully updated the copy of the transaction data at the enlisted node. Processing logic sends a message to the enlisted nodes to rollback to the previous state to preserve data consistency amongst the copies of the transaction data. At block 517, processing logic releases the lock on the local transaction data and sends a message to the transaction originator node indicating that the update to the data is not successful at block 519.

If processing logic receives a successful acknowledgment from all of the enlisted nodes (block 509), processing logic updates the value in the local data for the first transaction using the key-pair received in the update request at block 515. Processing logic can store tracking data in the data store to determine whether a successful acknowledgment is received from all of the nodes. At block 517, processing logic releases the lock and sends a message to the transaction originator node indicating that the update to the multiple copies of data is successful for the transaction at block 519.

Processing logic may receive another update request to update for another transaction that uses the same data as the first transaction and/or processing logic may determine that there is an update request in the queue to update data for another transaction that uses the same data as the first transaction. Processing logic may execute method 500 for the next update request.

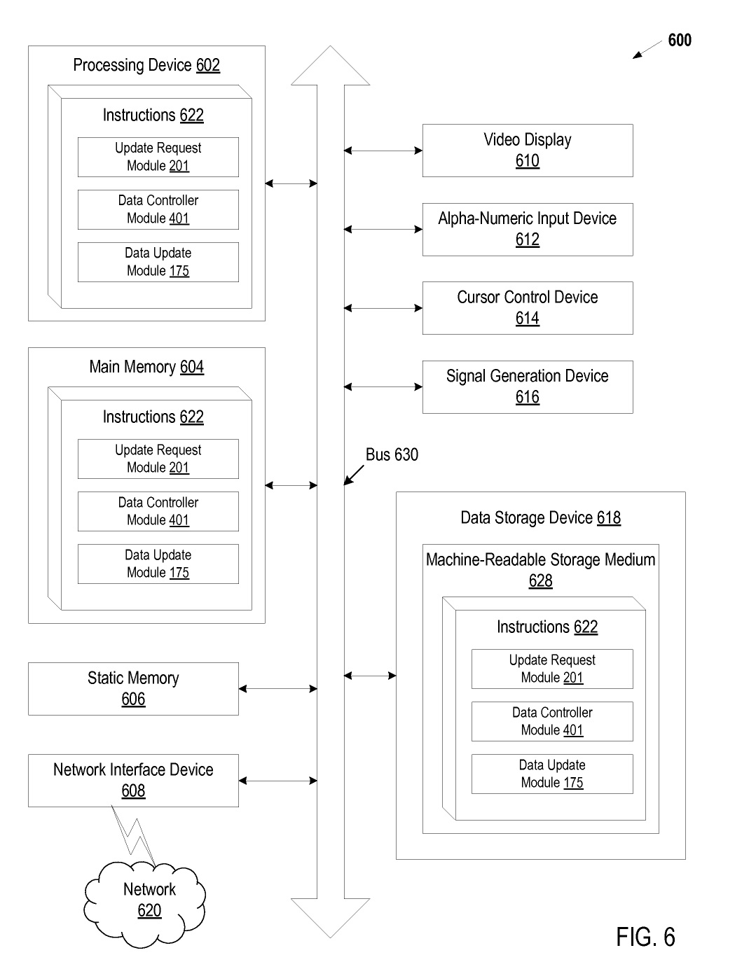

FIG. 6 illustrates a representation of a machine in the exemplary form of a computer system 600 within which a set of instructions, for causing the machine to perform any one or more of the methodologies discussed herein, may be executed. In alternative embodiments, the machine may be connected (e.g., networked) to other machines in a LAN, an intranet, an extranet, and/or the Internet. The machine may operate in the capacity of a server or a client machine in client-server network environment, or as a peer machine in a peer-to-peer (or distributed) network environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The exemplary computer system 600 includes a processing device 602, a main memory 604 (e.g., read-only memory (ROM), flash memory, dynamic random access memory (DRAM) such as synchronous DRAM (SDRAM) or DRAM (RDRAM), etc.), a static memory 606 (e.g., flash memory, static random access memory (SRAM), etc.), and a data storage device 618, which communicate with each other via a bus 630.

Processing device 602 represents one or more general-purpose processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 1202 may also be one or more special-purpose processing devices such as an application specific integrated circuit (ASIC), a field programmable gate array (FPGA), a digital signal processor (DSP), network processor, or the like. The processing device 602 is configured to execute instructions 622 for performing the operations and steps discussed herein.

The computer system 600 may further include a network interface device 608. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 616 (e.g., a speaker).

The data storage device 618 may include a machine-readable storage medium 628 (also known as a computer-readable medium) on which is stored one or more sets of instructions or software 622 embodying any one or more of the methodologies or functions described herein. The instructions 622 may also reside, completely or at least partially, within the main memory 604 and/or within the processing device 602 during execution thereof by the computer system 600, the main memory 604 and the processing device 602 also constituting machine-readable storage media.

In one embodiment, the instructions 622 include instructions for an update request module (e.g., update request module 201 of FIG. 2), a data controller module (e.g., data controller module 401 of FIG. 4), and/or a data update module (e.g., data update module 175 of FIG. 1) and/or a software library containing methods that call modules in an update request module, a data controller module, and/or a data update module. While the machine-readable storage medium 628 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present invention. The term “machine-readable storage medium” shall accordingly be taken to include, but not be limited to, solid-state memories, optical media and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving” or “locking” or “identifying” or “sending” or “determining” or “updating” or “releasing” or “ranking” or “accessing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present invention also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct a more specialized apparatus to perform the method. The structure for a variety of these systems will appear as set forth in the description below. In addition, the present invention is not described with reference to any particular programming language. It will be appreciated that a variety of programming languages may be used to implement the teachings of the invention as described herein.

The present invention may be provided as a computer program product, or software, that may include a machine-readable medium having stored thereon instructions, which may be used to program a computer system (or other electronic devices) to perform a process according to the present invention. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, embodiments of the invention have been described with reference to specific exemplary embodiments thereof. It will be evident that various modifications may be made thereto without departing from the broader spirit and scope of embodiments of the invention as set forth in the following claims. The specification and drawings are, accordingly, to be regarded in an illustrative sense rather than a restrictive sense.

What is claimed is:

1. A method comprising:
receiving, by a data controller node in a data grid, an update request to update data stored at the data controller node for a transaction managed by a transaction originator node;
locking the data for the transaction at the data controller node;
identifying a copy of the data residing at one or more other nodes in the data grid;
sending a message to the one or more other nodes to update the copy of the data at the one or more other nodes for the transaction without locking the copy of the data at the one or more other nodes;
determining whether an acknowledgment is received from each of the one or more other nodes that the copy of the data at the one or more other nodes are updated for the transaction; and
updating the locked data at the data controller node for the transaction in response to receiving the acknowledgment from each of the one or more other nodes.

2. The method of claim 1, further comprising:
releasing the lock on the data at the data controller node.

3. The method of claim 1, further comprising:
sending a message to each of the one or more other nodes to rollback data at the one or more other nodes to a previous state in response to not receiving the acknowledgment from each of the one or more other nodes; and
releasing the lock on the data at the data controller node.

4. The method of claim 1, further comprising:
locking the data at the data controller node for a second transaction managed by a second transaction originator node; and
sending a message to the one or more other nodes to update the copy of the data at the one or more other nodes for the second transaction without locking the copy of the data at the one or more other nodes.

5. The method of claim 1, further comprising:
sending a message to transaction originator node indicating whether the data stored at the data controller node is updated for the transaction.

6. A method comprising:
identifying, by a first transaction originator node in a data grid, data to lock for a first transaction managed by the first transaction originator node, wherein the data matches data for a second transaction managed by a second transaction originator node;
determining by the first transaction originator node, that copies of the data resides at a plurality of enlisted nodes;
determining, by the first transaction originator node, which of the plurality of enlisted nodes is a data controller node for the data for the first transaction, wherein the data controller node for the first transaction matches a data controller node for the second transaction; and
sending, by the first transaction originator node, an update request for the first transaction to the data controller node, wherein the data controller node acquires a lock on the data for the first transaction and sends a message to remaining enlisted nodes in the plurality of enlisted nodes to update a copy of the data at the corresponding enlisted node without acquiring a lock on the copy of the data at the corresponding enlisted node.

7. The method of claim 6, wherein determining which of the plurality of enlisted nodes is a data controller node comprises:
determining a hash value for each of the plurality of enlisted nodes using corresponding node identifiers; and
ranking the plurality of enlisted nodes based on the hash values.

8. The method of claim 7, wherein the data controller node is the enlisted node having one of a greatest hash value or a least hash value.

9. The method of claim 6, wherein determining which of the plurality of enlisted nodes is a data controller node comprises:
accessing a list of a plurality of nodes in the data grid; and
identifying the data controller node based on positions in the list of the enlisted nodes that correspond to the data for the first transaction.

10. A non-transitory computer-readable storage medium including instructions that, when executed by a processing device at a data controller node in a data grid, cause the processing device to perform a set of operations comprising:
receiving, by the data controller node, an update request to update data stored at the data controller node for a transaction managed by a transaction originator node;
locking the data for the transaction at the data controller node;
identifying a copy of the data residing at one or more other nodes in the data grid;
sending a message to the one or more other nodes to update the copy of the data at the one or more other nodes for the transaction without locking the copy of the data at the one or more other nodes;
determining whether an acknowledgment is received from each of the one or more other nodes that the copy of the data at the one or more other nodes are updated for the transaction; and
updating the locked data at the data controller node for the transaction in response to receiving the acknowledgment from each of the one or more other nodes.

11. The non-transitory computer-readable storage medium of claim 10, the operations further comprising:
releasing the lock on the data at the data controller node.

12. The non-transitory computer-readable storage medium of claim 10, the method further comprising:
sending a message to each of the one or more other nodes to rollback data at the one or more other nodes to a previous state in response to not receiving the acknowledgment from each of the one or more other nodes; and
releasing the lock on the data at the data controller node.

13. The non-transitory computer-readable storage medium of claim 10, the operations further comprising:
locking the data at the data controller node for a second transaction managed by a second transaction originator node; and
sending a message to the one or more other nodes to update the copy of the data at the one or more other nodes for the second transaction without locking the copy of the data at the one or more other nodes.

14. The non-transitory computer-readable storage medium of claim 10, the operations further comprising:
sending a message to transaction originator node indicating whether the data stored at the data controller node is updated for the transaction.

15. A system comprising:
a memory; and
a processing device in a data grid, the processing device coupled to the memory and configured to execute a process to
receive an update request to update data stored at the data controller node for a transaction managed by a transaction originator node,
lock the data for the transaction at the data controller node,
identify a copy of the data residing at one or more other nodes in the data grid,
send a message to the one or more other nodes to update the copy of the data at the one or more other nodes for the transaction without locking the copy of the data at the one or more other nodes,
determine whether an acknowledgment is received from each of the one or more other nodes that the copy of the data at the one or more other nodes are updated for the transaction, and
update the locked data at the data controller node for the transaction in response to receiving the acknowledgment from each of the one or more other nodes.

16. The system of claim 15, wherein the processing device is further configured to:
release the lock on the data at the data controller node.

17. The system of claim 15, wherein the processing device is further configured to:
send a message to each of the one or more other nodes to rollback data at the one or more other nodes to a previous state in response to not receiving the acknowledgment from each of the one or more other nodes; and
release the lock on the data at the data controller node.

18. The system of claim 15, wherein the processing device is further configured to:
lock the data at the data controller node for a second transaction managed by a second transaction originator node; and
send a message to the one or more other nodes to update the copy of the data at the one or more other nodes for the second transaction without locking the copy of the data at the one or more other nodes.

19. The system of claim 15, wherein the processing device is further configured to:
send a message to transaction originator node indicating whether the data stored at the data controller node is updated for the transaction.
